(19) United States
(12) Patent Application Publication
(10) Pub. No.: US 2026/0158633 A1
(43) Pub. Date: Jun. 11, 2026

(54) System and Method for Operating a Power Tool

(71) Applicant: Robert Bosch GmbH, Stuttgart (DE)

(72) Inventors: Robert Lewton, Arlington Heights, IL (US); Mitchell Wayne Burdick, Des Plaines, IL (US); Richard Monteverde, Chicago, IL (US); Ramon Tam, Buffalo Grove, IL (US); Ajai K. Verma, Lake Zurich, IL (US)

(21) Appl. No.: 18/977,617

(22) Filed: Dec. 11, 2024

(51) Int. Cl. B25F 5/00; B25F 5/02; B28D 1/04; H01M 10/42; H01M 10/48; H02P 23/20

(52) U.S. Cl. CPC B25F 5/001; B25F 5/02; H01M 10/425; H01M 10/48; H02P 23/20; B28D 1/045; H01M 2010/4278; H01M 2220/30

(57) ABSTRACT

A method of operating a power tool includes identifying a performance factor of a battery pack operably connected to the power tool using a controller of the power tool based on coded data received from the battery pack. The method also includes operating an electric motor of the power tool, using the controller, at a first maximum speed when the identified performance factor is greater than or equal to a threshold value, and operating the electric motor, using the controller, at a second maximum speed when the identified performance factor is less than the threshold value. The second maximum speed is less than the first maximum speed.

### FIELD

This disclosure relates to the field of power tools and, in particular, to power tools that are operated using a removable battery pack.

### BACKGROUND

Some power tools, such as concrete saws, routers, grinders, and drill drivers, are supplied with electrical energy from a removable battery pack. Battery packs are available different with different battery values, such as voltage and capacity. An operator of the power tool, however, may not recognize that a first battery pack has different battery values from a second battery pack. Accordingly, improvements to battery-powered power tools are desired so that the power tools are configured for optimal performance.

### SUMMARY

According to an exemplary embodiment of the disclosure, a method of operating a power tool includes identifying a performance factor of a battery pack operably connected to the power tool using a controller of the power tool based on coded data received from the battery pack. The method also includes operating an electric motor of the power tool, using the controller, at a first maximum speed when the identified performance factor is greater than or equal to a threshold value, and operating the electric motor, using the controller, at a second maximum speed when the identified performance factor is less than the threshold value. The second maximum speed is less than the first maximum speed.

According to another exemplary embodiment of the disclosure, a method of operating a power tool includes identifying a battery value of a battery pack operably connected to a power tool using a controller of the power tool based on coded data received from the battery pack. The method also includes operating an electric motor of the power tool, using the controller, at a first maximum speed when the battery value meets a battery condition, and operating the electric motor, using the controller, at a second maximum speed when the battery value does not meet the battery condition. The controller configures the power tool to perform power tool operations when the controller operates the electric motor at the first maximum speed. The controller prevents the power tool from performing the power tool operations when the controller operates the electric motor at the second maximum speed.

According to yet another exemplary embodiment of the disclosure a power tool includes an electric motor, and a controller. The controller is operably connected to the electric motor. The controller is configured to receive coded data from a battery pack operably connected to the power tool, and identify a performance factor of the battery pack based on the coded data. The controller is further configured to operate the electric motor at a first maximum speed when the identified performance factor is greater than or equal to a threshold value, and operate the electric motor at a second maximum speed when the identified performance factor is less than the threshold value. The second maximum speed is less than the first maximum speed.

### BRIEF DESCRIPTION OF THE FIGURES

The above-described features and advantages, as well as others, should become more readily apparent to those of ordinary skill in the art by reference to the following detailed description and the accompanying figures in which:

FIG. 1 is a block diagram of a power tool, as disclosed herein, that is configured for connection to a battery pack;

FIG. 2 illustrates an exemplary embodiment of the power tool of FIG. 1, shown as a battery-powered concrete saw;

FIG. 3 shows a battery door of the power tool of FIG. 2 in an open position with a battery pack located in a battery compartment and operably connected to an interface of the power tool;

FIG. 4 shows the battery pack being removed from the battery compartment and disconnected from the interface of the power tool; and

FIG. 5 is a flowchart illustrating an exemplary method of operating the power tool of FIG. 1.

### DETAILED DESCRIPTION

For the purpose of promoting an understanding of the principles of the disclosure, reference will now be made to the embodiments illustrated in the drawings and described in the following written specification. It is understood that no limitation to the scope of the disclosure is thereby intended. It is further understood that this disclosure includes any alterations and modifications to the illustrated embodiments and includes further applications of the principles of the disclosure as would normally occur to one skilled in the art to which this disclosure pertains.

Aspects of the disclosure are disclosed in the accompanying description. Alternate embodiments of the disclosure and their equivalents may be devised without parting from the spirit or scope of the disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

For the purposes of the disclosure, the phrase “A and/or B” means (A), (B), or (A and B). For the purposes of the disclosure, the phrase “A, B, and/or C” means (A), (B), (C), (A and B), (A and C), (B and C), or (A, B and C).

The terms “comprising,” “including,” “having,” and the like, as used with respect to embodiments of the disclosure, are synonymous.

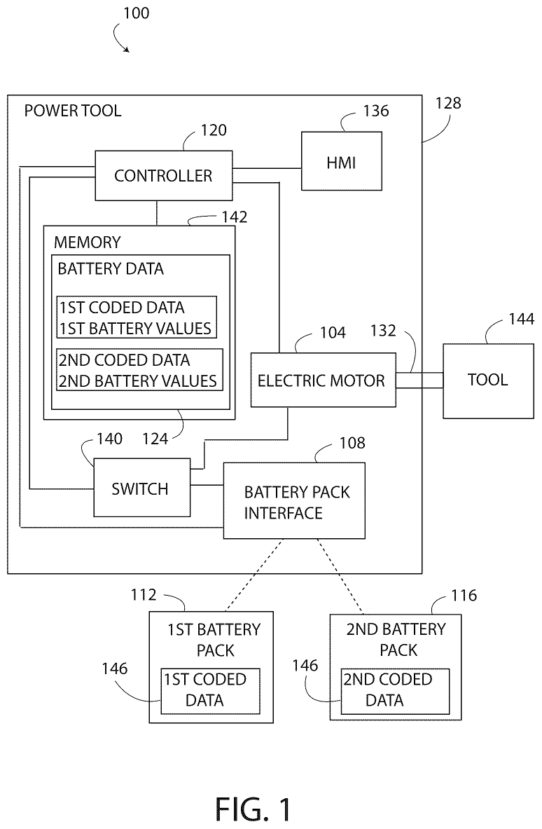

As shown in FIG. 1, a power tool 100 includes an electric motor 104 and an interface 108 that is configured for connection to a battery pack 112, 116. A controller 120 of the power tool 100 is configured to identify battery data 124 associated with the connected battery pack 112, 116. The battery data 124 includes at least one battery value of the battery pack 112, 116 that is connected to the power tool 100, such as a performance factor of the battery pack 112, 116. The controller 120 is configured to operate the electric motor 104 based on the battery value of the battery data 124. Specifically, the controller operates the electric motor 104 in a normal state when the battery value meets a battery condition, and the controller operates the electric motor 104 in a derated state when the battery value does not meet the battery condition. In the derated state, a maximum rotational speed and acceleration rate of the electric motor 104 is limited, such that the power tool 100 cannot be used to perform power tool operations. In the derated state, the controller 120 protects the battery pack 112, 116 by preventing the power tool 100 from drawing an excessive electrical current from the battery pack 112, 116. Each element of the power tool 100 and a method 500 for operating the power tool 100 are described herein.

The electric motor 104 is located within a housing 128 of the power tool 100. In one embodiment, the electric motor 104 is provided as a brushless direct current (BLDC) electric motor 104. In another embodiment, the electric motor 104 is provided as a brushed motor or any other type of electric motor suitable for use in a portable handheld power tool. The electric motor 104 receives power from the battery pack 112, 116 and is configured to rotate a motor shaft 132 during operation of the power tool 100.

The interface 108 is configured to operably connect to a battery pack 112, 116 in order to electrically and mechanically connect the battery pack 112, 116 to the power tool 100. The battery packs 112, 116 are removably connected to the interface 108.

With continued reference to FIG. 1, the power tool 100 further includes a human machine interface (HMI 136), a switch 140, and an electronic memory 142. The HMI 136, in one embodiment, includes an electronic display screen for displaying power tool information to the operator of the power tool 100. For example, the HMI 136 displays a state of charge of the connected battery pack 112, 116. The HMI 136 is operably connected to the controller 120. The HMI 136, in another embodiment, is provided as at least three different colored light emitting diodes, such as red, yellow, and green.

The HMI 136 further displays a status of the power tool 100 according to three different status levels including (i) a first status in which the power tool 100 is in the normal mode and is ready for operation, (ii) a second status in which the power tool 100 is warning the operator of a condition of the power tool 100 and/or the connected battery pack 112, 116 (such as when the power tool 100 is in the derated state), and (iii) a third status in which the power tool 100 is in an error state and/or the battery pack 112, 116 is fully discharged. The first status is also referred to herein as a ready status, the second status is also referred to herein as a warning status, and the third status is also referred to herein as a stop status. The ready status is shown by the HMI 136 by illuminating a symbol with a green color. The warning status is shown by the HMI 136 by illuminating the symbol with a yellow color. The stop status is shown by the HMI 136 by illuminating the symbol with a red color.

The switch 140 is a power switch of the power tool 100 that is operated by the user of the power tool 100 to turn on and to turn off the electric motor 104 during use of the power tool 100. The switch 140 is operably connected to the electric motor 104, the interface 108, and the controller 120. The switch 140 is operably connected to the connected battery pack 112, 116 through the interface 108.

The switch 140 is positionable in a first position and a second position. In the first position, which is also referred to as an “off” position, the electric motor 104 is off and does not move the motor shaft 132. In the second position, which is also referred to as an “on” position, the electric motor 104 moves the motor shaft 132 using electrical energy from the connected battery pack 112, 116.

As shown in FIG. 1, the electronic memory 142 is configured to store the battery data 124 of the battery pack 112, 116. For example, in one embodiment, the electronic memory 142 stores a lookup table of the battery data 124 that associates coded data 146 from the battery pack 112, 116 with at least one battery value of the battery pack 112, 116. The electronic memory 142 is a non-transitory electronic memory. The electronic memory 142 is also configured to store program instruction data for operating the controller 120.

The controller 120 is operably connected to the electric motor 104, the interface 108, the connected battery pack 112, 116, the HMI 136, the switch 140, and the electronic memory 142. The controller 120 is configured to execute the program instruction data in order to operate the power tool 100. The controller 120 is provided as at least one microcontroller and/or microprocessor.

The controller 120 is configured to control the rotation of the motor shaft 132 of the electric motor 104 based on the position of the switch 140. For example, when the switch 140 is moved to the “on” position, the controller 120 is configured to cause the electric motor 104 to be supplied with electrical energy from the battery pack 112, 116, which results in movement of the motor shaft 132. When the switch 140 is in the “off” position, the controller 120 is configured to cause the electric motor 104 to be electrically disconnected from the battery pack 112, 116 so that the electric motor 104 is off and the motor shaft 132 does not move. When the switch 140 is in the “on” position, the controller 120 operates the electric motor 104 at either a first maximum speed and acceleration rate of the motor shaft 132 (in the normal state) or a much slower second maximum speed and acceleration rate of the motor shaft 132 (in the derated state) based on the configuration and/or type of the battery pack 112, 116, as determined from the battery value.

The battery pack 112, 116 includes a plurality of battery cells (not shown) each configured to supply electrical energy to the power tool 100. The battery pack 112, 116 is rechargeable. In one embodiment, the battery pack 112, 116 is provided as a lithium-ion type of battery. The electrical energy for operating the electric motor 104, the controller 120, the HMI 136, and the electronic memory 142 is provided by the battery pack 112, 116 that is connected to the interface 108.

With reference to FIG. 1, in the exemplary embodiment, both the battery pack 112 and the battery pack 116 are connectable to the interface 108. Thus each battery pack 112, 116 includes the same type of physical interface for making a mechanical and electrical connection to the power tool 100. The battery packs 112, 116, however, are different in that the battery packs 112, 116 include different electrical characteristics and/or electrical properties of the internal battery cells. For example, the battery pack 112 has a nominal voltage of 18V, a capacity of 4 Ah, and a performance factor of 60. Whereas, the battery pack 116 has a nominal voltage of 18V, a capacity of 6 Ah, and a performance factor of 120. Thus, both battery packs 112, 116 have the same nominal voltage, but have different capacities and different performance factors, this results in the battery packs 112, 116 being able to reliably supply different amount of electrical current for different amounts of time.

The nominal voltage of the battery pack 112, 116 is an average voltage output by the battery cells when the battery pack is fully charged. Exemplary nominal voltages include, but are not limited to, 12V, 18V, 36V, and 48V. The nominal voltage is an exemplary battery value of the battery pack 112, 116 that is included in the battery data 124.

The capacity is a measure of the amount of energy that the battery cells of the battery pack 112, 116 can store and deliver. The capacity is measured in ampere-hours (Ah) or watt-hours (Wh). Exemplary capacities of the battery pack 112, 116 range from 1 Ah to 10 Ah. The capacity is an exemplary battery value of the battery pack 112, 116 that is included in the battery data 124.

The performance factor is a measure of the continuous current draw from the battery pack 112, 116. More specifically, the performance factor defines the continuous amperes that can be drawn from the battery pack. The performance factor is an exemplary battery value of the battery pack 112, 116 that included in the battery data 124. In one embodiment, the performance factor is a ratio of the rated ampere-hour capacity of the battery pack 112, 116 to the amperes the battery pack 112, 116 can supply at a given end of discharge voltage and for a specific time at 25° C. The performance factor is typically a fixed value of the battery pack 112, 116 that is provided by the manufacturer of the battery pack 112, 116, the battery cells, and/or the power tool 100.

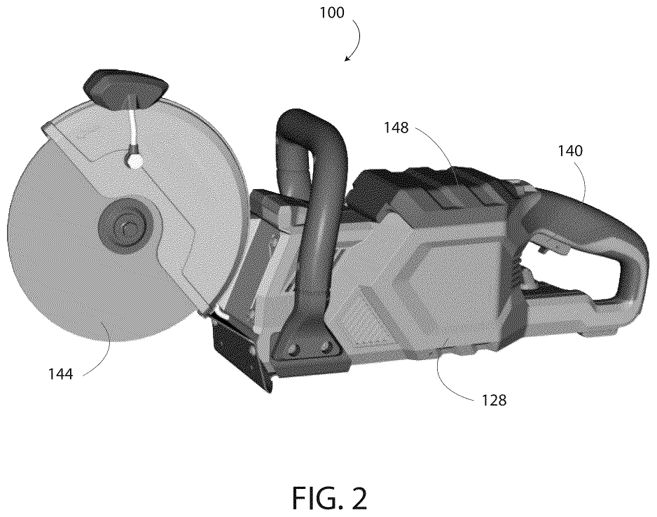

The performance factor is representative of the electrical “size” of the battery pack 112, 116. A battery pack 112, 116 having a bigger performance factor delivers a specified current for a longer period of time than a battery pack having a smaller performance factor. Thus, a battery pack 112, 116 having a larger performance factor is suitable for operating a power tool having larger energy requirements than a typical power tool. For example, an exemplary power tool provided as a drill driver typically does not require a battery pack 112, 116 with as large of a performance factor as an exemplary power tool provided as a circular saw for hardwood and/or a cutoff machine for cutting concrete (see FIGS. 2-4). The method 500 described below ensures that the power tool 100 is operated with a battery pack 112, 116 having a suitable performance factor.

The battery packs 112, 116 include electronic coded data 146 that encodes and/or is associated with the battery values (e.g., the nominal voltage, the capacity, and/or the performance factor) of the battery data 124. In one embodiment, the battery pack 112, 116 includes at least one coding resistor having a predetermined electrical resistance value that is the coded data 146. For example, the coded data 146 of the battery pack 112 is an electrical resistance of 125 ohms, and the coded data 146 of the battery pack 116 is an electrical resistance of 525 ohms. Any other predetermined electrical resistance value and/or electrical quantity may be used as the coded data 146.

With reference again to FIG. 1, the power tool 100 is configured to move a tool 144 that is operably connected to the motor shaft 132 of the electric motor 104. In one embodiment, the tool 144 is provided as disc, such as a circular saw blade or an abrasive cutting wheel. In another embodiment, the tool 144 is a drill bit, such as for a hammer drill. The electric motor 104 moves the tool 144 to perform power tool operations including cutting, grinding, shaping, polishing, driving fasteners, and/or nailing fasteners.

In some embodiments, a transmission (not shown) is located between the motor shaft 132 and the tool 144. Accordingly, the motor shaft 132 and the tool 144 may rotate at different speeds during operation of the power tool 100.

A specific example of the power tool 100 is shown in FIGS. 2-4. The power tool 100 is shown as a concrete cutoff tool, which is also known as a concrete saw. The tool 144 is provided as an abrasive wheel for cutting and/or scoring concrete.

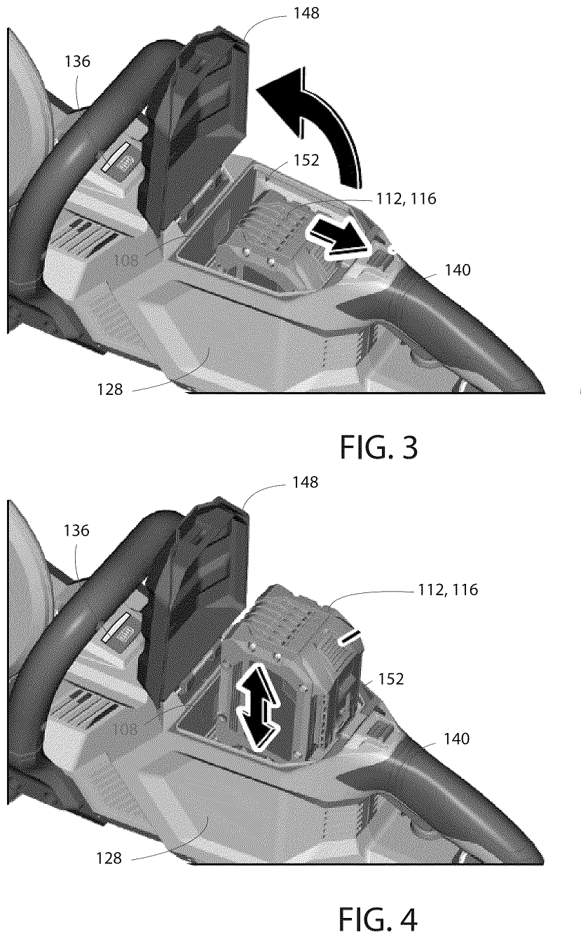

As shown in FIGS. 3 and 4, the housing 128 includes a battery door 148 that provides access to a battery compartment 152. The interface 108 is located in the battery compartment 152. One of the battery packs 112, 116 is removably positioned in the battery compartment for electrical and mechanical connection to the interface 108. When the battery door 148 is closed, the battery compartment 152 is sealed from the outside environment to protect the battery pack 112, 116 and the interface 108 from dust and debris generated by the tool 144.

Although the power tool 100 is illustrated as a cutoff tool in FIGS. 2-4, in other embodiments, the power tool 100 is provided as any type of battery-operated power tool 100 including circular saws, jigsaws, drill drivers, sanders, grinders, oscillating tool, routers, rotary tools, impact drivers, and nail guns.

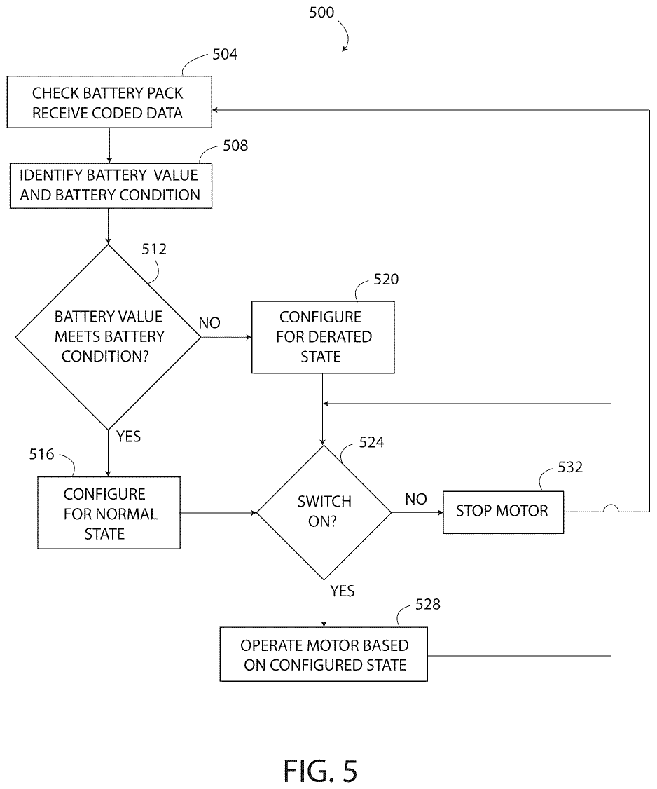

With reference to FIG. 5, the power tool 100 is operated according to an exemplary method 500. As described, the power tool 100 operates in either the normal state or the derated state based on the identified battery value of the battery pack 112, 116. For example, when the identified battery value meets a battery condition (e.g., a threshold value), then the power tool 100 is operated in the normal state in which the electric motor 104 rotates the motor shaft 132 and moves the tool 144 at full speed. When the identified battery value does not meet the battery condition, then the power tool 100 is operated in the derated state in which the electric motor 104 rotates the motor shaft 132 at very much less than the full speed. The tactile and auditory feedback that the operator receives with the power tool 100 operating in the derated state informs the operator that the connected battery pack 112, 116 is unsuitable for use with the power tool 100. The method 500 is described in full herein.

At block 504 of the method 500, the operator connects the battery pack 112, 116 to the interface 108 of the power tool 100. Either the battery pack 112 or the battery pack 116 is connected to the interface 108. After the battery pack 112, 116 is mechanically connected to the interface 108, the controller 120 checks for an electronic connection of the battery pack 112, 116 by obtaining or attempting to obtain the coded data 146 from the battery pack 112, 116. In one embodiment, the controller 120 receives the coded data 146 by electrically communicating with the battery pack 112, 116 through the interface 108. For example, the controller 120 determines the predetermined electrical resistance of the coding resistor of the battery pack 112, 116 to obtain the coded data 146. When the controller 120 receives the coded data 146, the controller 120 determines that the battery pack 112, 116 is electrically connected.

Additionally, at block 504, the controller 120 determines if the same or if a different battery pack 112, 116 is connected. That is, at block 504, the controller 120 determines if the battery pack 112, 116 has been exchanged for a different battery pack 112, 116. The controller 120 identifies an exchanged battery pack 112, 116 based on a comparison of first received coded data 146 with second received coded data 146, as provided by the battery packs 112, 116.

Next, at block 508 of the method 500, the controller 120 identifies the battery value(s) of the connected battery pack 112, 116 and the corresponding battery condition(s). To identify the battery value, the controller 120 uses the received coded data 146 and the electronic lookup table stored in the electronic memory 142. Specifically, the coded data 146 “points” to the battery value(s) in the lookup table of battery data 124. The lookup table includes the battery values of all of the battery packs 112, 116 that are connectable to the power tool 100. The battery value is at least one of the nominal voltage, the capacity, and/or the performance factor of the connected battery pack 112, 116.

The nominal voltage and the capacity are sometimes printed on the exterior of the battery pack 112, 116, but the performance factor is not typically printed on the battery pack 112, 116. Thus, the user may be unsure if the selected battery pack 112, 116 is suitable for use with the power tool simply by looking at the battery pack 112, 116.

The at least one battery condition is also stored in the memory 142 and is identified at block 508. The battery condition specifies a requirement of the battery value. The battery condition, in one embodiment, is based on the power demands of the power tool 100 and/or the capabilities of the connected battery pack 112, 116. In this example, the battery condition is a threshold value of the performance factor that is based on the power demands of the power tool 100. Specifically, the battery condition requires that the performance factor of the connected batter pack 112, 116 is greater than or equal to 90. In other embodiments, the battery condition is a threshold value of the nominal voltage, the capacity, and/or any other battery parameter.

As mentioned, the magnitude of the battery condition is determined based on the requirements of the power tool 100. In the illustrated example, the power tool 100, is a concrete cutoff tool having high power requirements. The power requirements of the power tool 100 typically cannot be met by a battery pack 112, 116 having low K-value (e.g., lower than the threshold value). Thus, the magnitude of the battery condition is predetermined by the manufacturer. The magnitude of the battery condition typically cannot be changed by the operator of the power tool 100. The magnitude of the other battery conditions (e.g., nominal voltage and capacity) are determined to optimize operation of the power tool 100 and/or the battery pack 112, 116.

At block 512 of the method 500, the controller 120 determines if the battery value meets the battery condition. Specifically, the controller 120 compares the identified battery value of the battery pack 112, 116 to the battery condition. When the battery value meets the battery condition, the power tool 100 is operated in the normal state of block 516. When the battery value does not meet the battery condition, the power tool 100 is operated in the derated state of block 520.

The battery value meets the battery condition, when, for example, the battery value exceeds a threshold value. Regarding the performance factor example, when the battery pack 112 is connected, the battery value is a performance factor of 60, which does not meet the battery condition having a threshold value of 90. Thus, when the battery pack 112 is connected the battery value does not meet the battery condition. However, when the battery pack 116 is connected, the battery value is a performance factor of 120, which meets the battery condition by exceeding the threshold value of 90. Thus, when the battery pack 116 is connected the battery value meets the battery condition.

At block 516 of the method 500, the battery pack 116 is connected, and the controller 120 configures the power tool 100 in the normal state, which is also referred to as the normal operating state. In the normal state, the controller 120 sets the operating speed of the electric motor 104 to a first maximum speed that is 100% of a full speed of the electric motor 104. The electric motor 104 is also set to a first rate of acceleration that is a full acceleration (100% acceleration) of the electric motor 104. Moreover, at block 516, the controller 120 causes the HMI 136 to indicate that the power tool 100 is ready for operation, such as by illuminating the HMI 136 in a green color to identify the ready status.

By configuring the HMI 136 in the ready status with the battery pack 116 connected, the power tool 100 informs the user that the connected battery pack 116 is suitable for use with the power tool 100 to perform cutting operations. The HMI 136 identifies the ready status with the switch 140 in the “off” position so that the user does not need to power on the power tool 100 to determine that the battery pack 116 is suitable for use.

At block 520 of the method 500, the battery pack 112 is connected, and the controller 120 configures the power tool 100 in the derated state, which is also referred to as the derated operating state. In the derated state, the controller 120 sets the operating speed of the electric motor 104 to a second maximum speed that is less than the first maximum speed. Specifically, the second maximum speed is less than 5% of the full speed, and is substantially less than the full speed. In other embodiments, the second maximum speed is from 1% to 10% of the full speed, but is still substantially less than the full speed. Additionally, in derated state the controller 120 sets the electric motor 104 to a second rate of acceleration that is substantially less than the first rate of acceleration. In particular, the second rate of acceleration is 10% of the first rate of acceleration. In other embodiments, the second rate of acceleration is from 3% to 20% of the first rate of acceleration and is still substantially less than the first rate of acceleration.

Moreover, at block 520, the controller 120 causes the HMI 136 to display that the power tool 100 is in the warning status, such as by illuminating the HMI 136 in a yellow color. The HMI 136 illuminated in yellow is a warning to the user that the battery value of the connected battery pack 112 does not meet the battery condition and that the power tool 100 is not ready for operation. The HMI 136 illuminated in yellow is displayed for both positions of the switch 140, so that the user does not have to power on the power tool 100 to determine that the battery pack 112 is unsuitable for operation with the power tool 100.

At block 524 of the method 500, the controller 120 determines when the switch 140 is in the “on” position and when the switch is in the “off” position.

At block 528, when the switch 140 is in the “on” position, the controller 120 causes the electric motor 104 to operate at the maximum speed that was set in either block 516 or block 520.

Specifically, at block 528, when the battery pack 116 is connected and the power tool 100 is configured in the normal state, the controller 120 causes the motor shaft 132 and the tool 144 to accelerate at the first rate of acceleration to the first maximum speed, which is the full speed of the electric motor 104. Thus, the power tool 100 moves the tool 144 at a normal and expected rate of movement for performing power tool operations using the tool 144. Moreover, the controller 120 illuminates the HMI 136 to indicate the ready state.

The power tool 100 when operated in the normal state is configured to perform power tool operations. For example, in use when the tool 144 is moved at the full maximum speed, the tool 144 (e.g. a circular saw blade or an abrasive cutting wheel) cuts a corresponding workpiece when placed in contact therewith, as expected.

At block 528, when the battery pack 112 is connected and the switch 140 is in the “on” position, the power tool 100 is operated in the derated state. In the derated state, the controller 120 causes the motor shaft 132 and the tool 144 to accelerate at the second rate of acceleration to the second maximum speed, which is substantially less than the first maximum speed. Thus, the power tool 100 moves the tool 144 at a visibly slow and unexpected rate of movement. Moreover, the controller 120 illuminates the HMI 136 to indicate the warning state and to indicate that the power tool 100 is not configured for performing power tool operations. When the power tool 100 is configured in the derated state, the controller 120 prevents the power tool 100 from performing the power tool operations.

In the derated state, upon hearing the electric motor 104 slowly accelerate to the derated speed (e.g., the second maximum speed), seeing the slow movement of the tool 144, and feeling the difference in vibrations of the power tool 100, the operator may take several actions. First, the operator may check the HMI 136 and learn that the power tool 100 is operating in the warning state/derated state. The operator may then use the switch 140 to turn off the electric motor 104. Next, the operator may refer to an instruction manual of the power tool 100 to learn why the power tool 100 is operating differently. Typically, the operator will quickly learn that the connected battery pack 112 is unsuitable and will then connect a suitable battery pack 116.

Second, the operator may attempt to perform a power tool operation with the power tool 100 configured in the derated state. However, the controller 120 does not permit power tool operations to be performed with an unsuitable battery pack 112 connected. For example, when power tool 100 is in the derated state, the controller 120 operates the electric motor 104 with very little power so that the tool 144 stops moving/rotating completely when the tool 144 contacts a workpiece, thereby preventing the power tool operations. The controller 120 operates the electric motor 104 at no more than the second maximum speed in the derated state.

Thus, when operating in the derated state, the operator receives tactile and auditory feedback and is informed that the electric motor 104 is operable and that the connected battery pack 112 is at least partially charged. However, the operator cannot use the power tool 100 to perform power tool operations, because the controller 120 supplies the electric motor 104 with only enough electric power to slowly rotate or move the tool 144. As soon as a resistive force is applied to the tool 144, the controller 120 detects the increased current draw from the electric motor 104 and rotation or movement of the tool 144 is halted and/or further slowed to prevent the power tool operation. The power tool 100 is unusable when operated using the battery pack 112 having a battery value that fails to meet the battery condition.

Returning to block 524 of the method 500, when the switch 140 is in the “off” position, controller 120 stops or tuns off the electric motor 104 as indicated at block 532.

Next, the method 500 returns to block 504 wherein the controller 120 detects if a different battery pack 112, 116 is connected to the power tool 100.

The method 500 improves the operation of a battery-operated power tool 100 by providing direct feedback to the operator regarding the connected battery pack 112, 116. When the battery pack 116 is connected to the power tool 100 having a battery value that meets or exceeds the battery condition, the power tool 100 operates in the normal state at full rotational speed and/or full movement speed of the tool 144.

When the battery pack 112 is connected to the power tool 100 having a battery value that fails to meet the battery condition, the power tool 100 operates in the derated state and is unusable for power tool operations. The user is provided with tactile and auditory feedback that the power tool 100 is unusable, when the tool 144 accelerates slowly and rotates or moves slowly. In the derated state, contacting the tool 144 to a workpiece stops movement of the tool 144 instead of cutting the workpiece. The user is provided with information that the battery pack 112 is at least partially charged and information that the electric motor 104 is functional. This is compared to failing to move the tool 144 at all when the unsuitable battery pack 112 is connected, which could confuse the operator into thinking that the battery pack 112 is suitable for use but needs to be recharged.

The method 500 also prevents the need for manufacturers to have different physical configurations of the interface 108 for each type of battery pack 112, 116. Instead, of physically locking out the unsuitable battery pack 112 by preventing the mechanical and electrical connection to the interface 108, the method 500 uses a software approach to ensure that the power tool 100 is operable only with the suitable battery pack 116.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A method of operating a power tool, comprising:
identifying a performance factor of a battery pack operably connected to the power tool using a controller of the power tool based on coded data received from the battery pack;
operating an electric motor of the power tool, using the controller, at a first maximum speed when the identified performance factor is greater than or equal to a threshold value; and
operating the electric motor, using the controller, at a second maximum speed when the identified performance factor is less than the threshold value,
wherein the second maximum speed is less than the first maximum speed.

2. The method of claim 1, further comprising:
displaying a warning, using a human machine interface of the power tool, when the identified performance factor is less than the threshold value.

3. The method of claim 2, wherein:
the power tool includes a power switch that is positionable in a first position and a second position,
in the first position, the electric motor is off, and
in the second position, the controller operates the electric motor at the first maximum speed or the second maximum speed.

4. The method of claim 3, wherein the controller configures the human machine interface to display the warning when the power switch is in the first position and when the power switch is in the second position.

5. The method of claim 1, wherein:
the first maximum speed is suitable for performing a power tool operation using a tool operably connected to the electric motor, and
the second maximum speed is unsuitable for performing the power tool operation using the tool.

6. The method of claim 5, wherein the power tool operation is cutting, grinding, shaping, and/or polishing.

7. The method of claim 1, wherein:
the first maximum speed is a full speed of the electric motor, and
the second maximum speed is less than 25% of the full speed of the electric motor.

8. The method of claim 7, further comprising:
accelerating a motor shaft of the electric motor to the first maximum speed at a first rate of acceleration; and
accelerating the motor shaft to the second maximum speed at a second rate of acceleration,
wherein the second rate of acceleration is less than the first rate of acceleration.

9. The method of claim 8, wherein:
the second rate of acceleration is 10% of the first rate of acceleration.

10. A method of operating a power tool, comprising:
identifying a battery value of a battery pack operably connected to a power tool using a controller of the power tool based on coded data received from the battery pack;
operating an electric motor of the power tool, using the controller, at a first maximum speed when the battery value meets a battery condition; and
operating the electric motor, using the controller, at a second maximum speed when the battery value does not meet the battery condition,
wherein the controller configures the power tool to perform power tool operations when the controller operates the electric motor at the first maximum speed, and
wherein the controller prevents the power tool from performing the power tool operations when the controller operates the electric motor at the second maximum speed.

11. The method of claim 10, wherein:
the battery value is a performance factor of the battery pack,
the battery condition is met when the performance factor is greater than or equal to a threshold value, and
the battery condition is not met when the performance factor is less than the threshold value.

12. The method of claim 10, wherein:
the power tool operation is cutting, grinding, shaping, and/or polishing using a tool operably connected to the electric motor, and
the controller prevents the tool from cutting, grinding, shaping, and/or polishing by operating the electric motor at no more than the second maximum speed.

13. The method of claim 10, further comprising:
displaying a warning, using a human machine interface of the power tool, when the battery value does not meet the battery condition.

14. The method of claim 13, wherein:
the power tool includes a power switch that is positionable in a first position and a second position,
in the first position, the electric motor is off, and
in the second position, the controller operates the electric motor at the first maximum speed or the second maximum speed.

15. The method of claim 14, wherein the controller configures the human machine interface to display the warning when the power switch is in the first position and when the power switch is in the second position.

16. The method of claim 10, wherein:
the first maximum speed is a full speed of the electric motor, and
the second maximum speed is less than 25% of the full speed of the electric motor.

17. The method of claim 16, further comprising:
accelerating a motor shaft of the electric motor to the first maximum speed at a first rate of acceleration; and
accelerating the motor shaft to the second maximum speed at a second rate of acceleration,
wherein the second rate of acceleration is 10% of the first rate of acceleration.

18. A power tool, comprising:
an electric motor; and
a controller operably connected to the electric motor,
wherein the controller is configured to:
receive coded data from a battery pack operably connected to the power tool,
identify a performance factor of the battery pack based on the coded data,
operate the electric motor at a first maximum speed when the identified performance factor is greater than or equal to a threshold value, and
operate the electric motor at a second maximum speed when the identified performance factor is less than the threshold value, and
wherein the second maximum speed is less than the first maximum speed.

19. The power tool of claim 18, wherein:
the battery pack is a first battery pack having a first nominal voltage and a first performance factor,
a second battery pack has a second nominal voltage and a second performance factor,
the first nominal voltage is equal to the second nominal voltage,
the first performance factor is greater than the threshold value,
the second performance factor is less than the threshold value,
the controller is configured to operate the electric motor at the first maximum speed when the first battery pack is operably connected to the power tool, and
the controller is configured to operate the electric motor at the second maximum speed when the second battery pack is operably connected to the power tool.

20. The power tool of claim 18, further comprising:
a human machine interface operably connected to the controller, the controller configured to display a warning, using the human machine interface, when the identified performance factor is less than the threshold value; and
a power switch operably connected to the electric motor, the power switch positionable in a first position and a second position,
wherein, in the first position, the electric motor is off,
wherein, in the second position, the controller operates the electric motor at the first maximum speed or the second maximum speed, and
wherein the controller configures the human machine interface to display the warning when the power switch is in the first position and when the power switch is in the second position.
